(19) United States
(12) Patent Application Publication
(10) Pub. No.: US 2017/0046737 A1
(43) Pub. Date: Feb. 16, 2017

(54) TAG MANAGEMENT SYSTEM FOR MANAGING TAGS ON WEB PAGES OF PUBLISHERS

(71) Applicant: SVG Media Pvt Ltd, New Delhi (IN)

(72) Inventors: Nitika SACHDEVA, Gurgaon (IN); Siddharth PURI, Gurgaon (IN)

(21) Appl. No.: 14/945,332

(22) Filed: Nov. 18, 2015

(30) Foreign Application Priority Data
Aug. 12, 2015 (IN) 2480/DEL/2015

(51) Int. Cl. G06Q 30/02; G06F 17/30

(52) U.S. Cl. CPC G06Q 30/0255; G06F 17/3089

(57) ABSTRACT

The present disclosure provides an advertisement tag management system for enabling management of a plurality of tags embedded on a plurality of web pages associated with one or more publishers. The advertisement tag management system includes a rule creation engine configured to define a plurality of rules for each of the plurality of tags embedded in each of the plurality of web pages, a receiving module configured to receive a first set of information associated with one or more event types on the corresponding one or more publishers, a tag execution engine configured to execute each of the plurality of tags based on a pre-determined criterion and a file generating module configured to generate a file based on changes in each of the plurality of tags. Each of the plurality of rules is defined based on the pre-determined criterion. The plurality of tags is contained in a tag container.

### TECHNICAL FIELD

The present disclosure relates to the field of online marketing and advertising. More specifically, the present disclosure relates to managing of advertising tags on web pages of one or more publishers for serving of advertisements.

### BACKGROUND

With the advent of technological advancements in the last few years, online advertising has evolved into a topmost advertising medium. Nowadays, a substantial amount of users spend their time browsing through the internet through their portable communication devices for various activities. In the current scenario, access to information about various users is easily accessible on web. Nowadays, every entity wants to publish, consume and aggregate content online and offline. Collection of data has become a part of their business for ensuring continuous and smooth running of business operations. These entities make use of this information for offering opportunities for online advertising or online marketing through their web pages. Different types of technologies are available which enable online publishers to access the information to gain in-depth insights. These technologies have become a latest trend across many areas of business.

In general, the information related to various users is collected by the online publishers by using various marketing tags on their web pages. Moreover, the prime purpose of using the marketing tags is serving one or more advertisements to the users online. These marketing tags correspond to HTML or Javascript codes which reside on web pages of websites Activation of these tags may take peace at any time during the loading of a web page of the online publishers based on one or more rules set by the website owners. Traditionally, these tags are enabled to track activities of online users including their buying habits, favorite products, online behavior and the like. Rapid expansion of digital marketing world has prompted marketing vendors to request the online publishers to integrate their tags on their web pages for generating revenue through serving of the one or more advertisements. These tags are contained in the HTML/Javascript code of the web pages and load each time the web page is requested from a web server of the online publisher and loaded.

Further, the tags are contained in a container tag which is responsible for managing all the tags on a web page of the online publishers. The container tag works on a pre-defined set of rules for executing or firing tags contained in the container tag. Online publishers include these one or more tags in the code of their web pages for enabling displaying of one or more advertisements in real time. Moreover, each tag corresponds to a specific advertiser of one or more advertisers who are permitted to serve the advertisements on the corresponding one or more publishers. In addition, these ad tags may be provided by advertisement supplying intermediaries like advertisement networks, advertisement exchanges, affiliates, advertisement agencies and the like.

Several systems and methods exist in the art for management and execution of tags contained in the container tag on the web pages of the online publishers. One such system performs the execution of the tags in the container tag based on the properties of the tag and based on a context of loading of the web page. Another such system manages the execution of tags for serving the one or more advertisements based on matching between the online publisher site tags and the advertisement tags of the corresponding advertisement. Yet another such system executes the tags in the container tags by selectively activating tags based on the user behavior and context. Yet another such system performs the management of tags by scanning a web page of the publisher for identifying page tags and matching one or more variables in the page tag to a vendor validation rule.

However, the present systems and methods for managing and executing the tags in the tag container are efficient. The present systems and methods do not allow the firing of each tag in the container tag based on certain conditions or events provided by the one or more advertisers. The absence of advertiser conditions often leads to execution of irrelevant tags which do not help in serving the right type of advertisements to the users in real time which results in wastage of advertisements and loss of revenue for both the publisher and the advertiser. Moreover, the present systems and methods do not allow firing of each tag based on specific actions taken by the one or more users which have been listed by the advertisers.

In the light of the above stated discussion, there is a need for a method and system that overcomes the above stated disadvantages and provides a better and efficient management of tags.

### SUMMARY

In an aspect of the present disclosure, a computer-implemented method for enabling management of a plurality of tags embedded on a plurality of web pages associated with one or more publishers is provided. The computer-implemented method includes defining, with a processor, a plurality of rules for each of the plurality of tags embedded in each of the plurality of web pages, receiving, with the processor, a first set of information associated with one or more event types on the corresponding one or more publishers, executing, with the processor, each of the plurality of tags based on the pre-determined criterion and generating, with the processor, a file based on changes in each of the plurality of tags. Each of the plurality of rules is defined based on a pre-determined criterion. Each rule of the plurality of rules is defined for execution of a corresponding tag of the plurality of tags. Each of the plurality of rules is defined by one or more advertisers. Each of the plurality of rules is created based on an event type. Each of the plurality of tags is contained in a tag container. The one or more event types corresponds to a specific set of pre-defined actions taken by one or more users on the corresponding one or more publishers containing the plurality of tags. The first set of information is received in real time. Each of the plurality of tags is executed based on the corresponding plurality of rules defined for each of the plurality of tags. A specific tag of the plurality of tags is executed on execution of the rule of the plurality of rules corresponding to the specific tag. The execution of each of the plurality of tags is based on the received first set of information. The file is created for each of the plurality of tags. The file is generated for determining the specific tag of the plurality of tags on the corresponding one or more publishers executed. The generated file is dynamically pushed to a server.

In an embodiment of the present disclosure, the computer-implemented method further includes dynamically updating, with the processor, each of the plurality of rules based on the pre-determined criterion, the first set of information associated with the one or more event types and a content corresponding to the generated file.

In an embodiment of the present disclosure, the pre-determined criterion includes one or more advertiser conditions provided by the one or more advertisers for the execution of each of the plurality of tags. Each of the one or more advertisers is associated with the corresponding tag of the plurality of tags. Each of the one or more advertiser conditions is provided for targeting a specific group of users for serving one or more advertisements.

In an embodiment of the present disclosure, the computer-implemented method further includes analyzing, with the processor, the generated file for determining the corresponding executed tag of the plurality of tags. The analyzing is done for recognizing an advertiser of the one or more advertisers associated with the corresponding executed tag of the plurality of tags.

In an embodiment of the present disclosure, the computer-implemented method further includes displaying, with the processor, an advertisement of the one or more advertisements to a user of the one or more users on a corresponding advertisement slot of one or more advertisement slots associated with a corresponding publisher of the one or more publishers based on the computation. The advertisement of the one or more advertisements is associated with the advertiser of the one or more advertisers associated with the corresponding tag of the plurality of tags are executed in real time.

In an embodiment of the present disclosure, a type of the plurality of rules includes at least one of a url rule, a variable rule and a cookie rule.

In an embodiment of the present disclosure, the execution of each of the plurality of tags is done based on a matching process. The matching process matches the one or more advertiser conditions provided by the one or more advertisers with the one or more event types on the corresponding one or more publishers. The matching is done for the execution of a relevant tag defined based on a matched advertiser condition of the one or more advertiser conditions.

In an embodiment of the present disclosure, the computer-implemented method further includes storing, with the processor, the plurality of rules, the plurality of tags, the first set of information associated with the one or more event types, information associated with the execution of each of the plurality of tags, the one or more advertiser conditions and information associated with the one or more users.

In an embodiment of the present disclosure, the event type is a function of one or more pre-defined matching techniques. The one or more pre-defined matching techniques include at least one of an exact match, no match, regular expression matching and conditional parameters matching.

In an embodiment of the present disclosure, each of the plurality of tags includes one or more tag supports. The one or more tag supports includes at least one of a platform level tag, a third party HTML tag and a third party URL tag.

In another aspect of the present disclosure, a computer-program product for enabling management of a plurality of tags embedded on a plurality of web pages associated with one or more publishers is provided. The computer-program product includes a computer readable storage medium having a computer program stored thereon for performing the steps of defining a plurality of rules for each of the plurality of tags embedded in each of the plurality of web pages, receiving a first set of information associated with one or more event types on the corresponding one or more publishers, executing each of the plurality of tags based on the pre-determined criterion and generating a file based on changes in each of the plurality of tags. Each of the plurality of rules is defined based on a pre-determined criterion. Each rule of the plurality of rules is defined for execution of a corresponding tag of the plurality of tags. Each of the plurality of rules is defined by one or more advertisers. Each of the plurality of rules is created based on an event type. Each of the plurality of tags is contained in a tag container. The one or more event types corresponds to a specific set of pre-defined actions taken by one or more users on the corresponding one or more publishers containing the plurality of tags. The first set of information is received in real time. Each of the plurality of tags is executed based on the corresponding plurality of rules defined for each of the plurality of tags. A specific tag of the plurality of tags is executed on execution of the rule of the plurality of rules corresponding to the specific tag. The execution of each of the plurality of tags is based on the received first set of information. The file is created for each of the plurality of tags. The file is generated for determining the specific tag of the plurality of tags on the corresponding one or more publishers executed. The generated file is dynamically pushed to a server.

In an embodiment of the present disclosure, the computer-program product further includes dynamically updating each of the plurality of rules based on the pre-determined criterion, the first set of information associated with the one or more event types and a content corresponding to the generated file.

In an embodiment of the present disclosure, the pre-determined criterion includes one or more advertiser conditions provided by the one or more advertisers for the execution of each of the plurality of tags. Each of the one or more advertisers is associated with the corresponding tag of the plurality of tags. Each of the one or more advertiser conditions is provided for targeting a specific group of users for serving one or more advertisements.

In yet another aspect of the present disclosure, a advertisement tag management system for enabling management of a plurality of tags embedded on a plurality of web pages associated with one or more publishers is provided. The advertisement tag management system includes a rule creation engine in a processor, the rule creation engine is configured to define a plurality of rules for each of the plurality of tags embedded in each of the plurality of web pages; a receiving module in the processor, the receiving module is configured to receive a first set of information associated with one or more event types on the corresponding one or more publishers; a tag execution engine in the processor, the tag execution engine is configured to execute each of the plurality of tags based on the pre-determined criterion and a file generating module in the processor, the file generating module is configured to generate a file based on changes in each of the plurality of tags. Each of the plurality of rules is defined based on a pre-determined criterion. Each rule of the plurality of rules is defined for execution of a corresponding tag of the plurality of tags. Each of the plurality of rules is defined by one or more advertisers. Each of the plurality of rules is created based on an event type. Each of the plurality of tags is contained in a tag container. The one or more event types corresponds to a specific set of pre-defined actions taken by one or more users on the corresponding one or more publishers containing the plurality of tags. The first set of information is received in real time. Each of the plurality of tags is executed based on the corresponding plurality of rules defined for each of the plurality of tags. A specific tag of the plurality of tags is executed on execution of the rule of the plurality of rules corresponding to the specific tag. The execution of each of the plurality of tags is based on the received first set of information. The file is created for each of the plurality of tags. The file is generated for determining the specific tag of the plurality of tags on the corresponding one or more publishers executed. The generated file is dynamically pushed to a server.

In an embodiment of the present disclosure, the advertisement tag management system further includes an updation engine in the processor, the updation engine is configured to dynamically update each of the plurality of rules based on the pre-determined criterion, the first set of information associated with the one or more event types and a content corresponding to the generated file.

In an embodiment of the present disclosure, the pre-determined criterion includes one or more advertiser conditions provided by the one or more advertisers for the execution of each of the plurality of tags. Each of the one or more advertisers is associated with the corresponding tag of the plurality of tags. Each of the one or more advertiser conditions is provided for targeting a specific group of users for serving one or more advertisements.

In an embodiment of the present disclosure, the advertisement tag management system further includes a computation engine in the processor, the computation engine is configured to analyze the generated file for determining the corresponding executed tag of the plurality of tags. The analyzing is done for recognizing an advertiser of the one or more advertisers associated with the corresponding executed tag of the plurality of tags.

In an embodiment of the present disclosure, the advertisement tag management system further includes an advertisement serving module in the processor, the advertisement serving module is configured to display an advertisement of the one or more advertisements to a user of the one or more users on a corresponding advertisement slot of one or more advertisement slots associated with a corresponding publisher of the one or more publishers based on the computation. The advertisement of the one or more advertisements is associated with the advertiser of the one or more advertisers associated with the corresponding tag of the plurality of tags executed in real time.

In an embodiment of the present disclosure, a type of the plurality of rules includes at least one of a url rule, a variable rule and a cookie rule.

In an embodiment of the present disclosure, the advertisement tag management system further includes a database in the processor, the database is configured for storing the plurality of rules, the plurality of tags, the first set of information associated with the one or more event types, information associated with the execution of each of the plurality of tags, the one or more advertiser conditions and information associated with the one or more users.

### BRIEF DESCRIPTION OF THE FIGURES

Having thus described the invention in general terms, reference will now be made to the accompanying drawings, which are not necessarily drawn to scale, and wherein:

FIG. 1A and FIG. 1B illustrates a general overview of a system for enabling management of a plurality of tags embedded on a plurality of web pages, in accordance with various embodiments of the present disclosure.

FIG. 2 illustrates a block diagram of a communication device, in accordance with various embodiments of the present disclosure.

FIG. 3 illustrates a flowchart for enabling the management of the plurality of tags embedded on the plurality of web pages, in accordance with various embodiments of the present disclosure.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

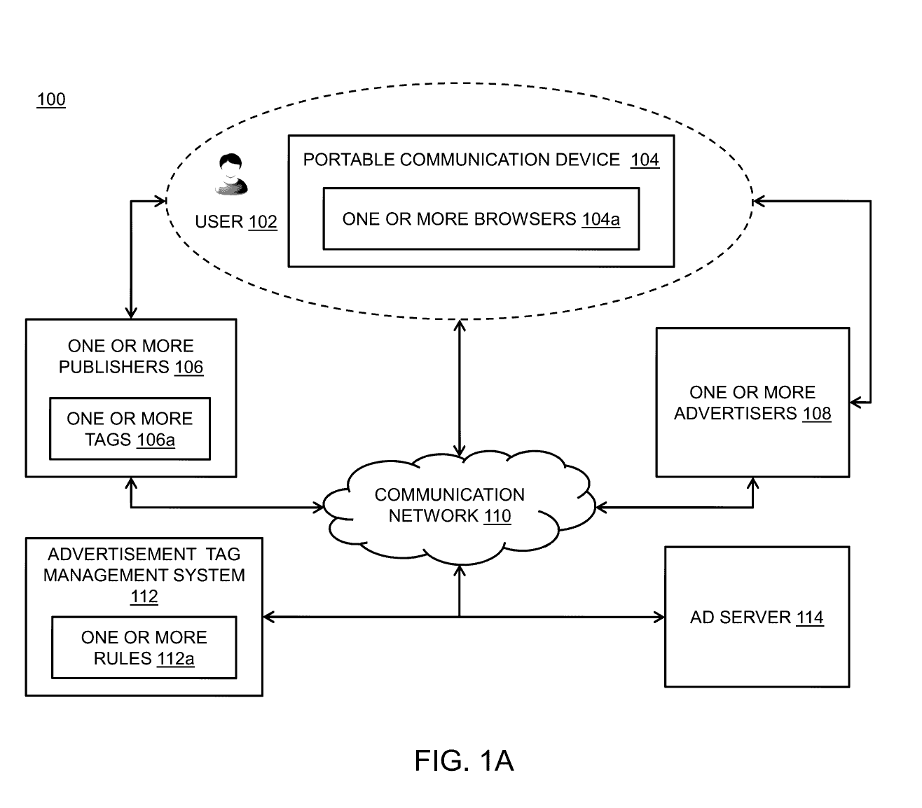

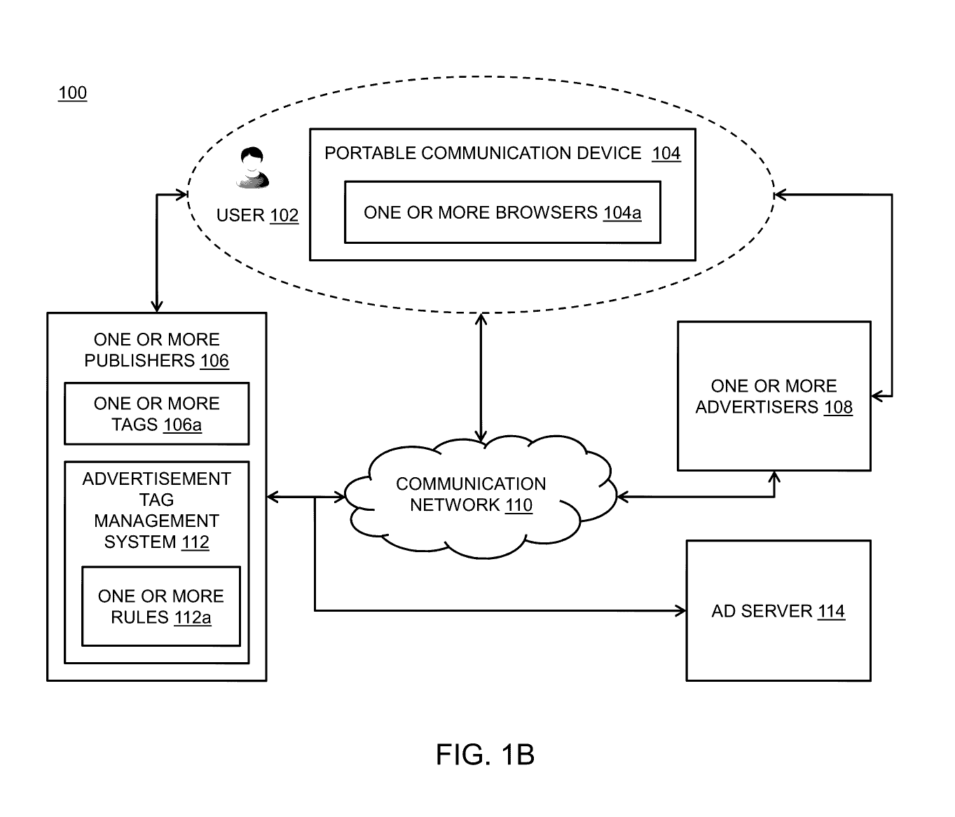

FIG. 1A illustrates a general overview of a system 100 for enabling management of a plurality of tags embedded on a plurality of web pages associated with one or more publishers, in accordance with various embodiments of the present disclosure. The system 100 includes a portable communication device 104 associated with a user 102, one or more publishers 106, one or more advertisers 108, a communication network 110, a advertisement tag management system 112 and an ad server 114. In addition, the advertisement tag management system 112 enables the managing of the plurality of tags embedded on the plurality of web pages associated with one or more publishers 106. The management of the plurality of tags is performed for serving one or more advertisements to one or more users in real time.

Going further, the system 100 enables the one or more publishers 106 to increase performance of the one or more advertisements and generate higher revenue by providing or serving the one or more advertisements by executing a corresponding relevant tag of the plurality of tags associated with an advertiser of the one or more advertisers 108 (as explained below in the patent application). In addition, the user 102 may be any person or individual currently accessing the portable communication device 104. In an embodiment of the present disclosure, the user 102 is an owner of the portable communication device 104. Examples of the portable communication device 104 include but may not be limited to a smart phone, a desktop computer, a laptop, a tablet, a personal digital assistant, a wearable device or any other portable communication device known in the art. In addition, the portable communication device 104 is associated with a specific type of operating system. The type of operating system associated with the portable communication device 104 includes but may not be limited to an Android operating system, iOS, Mac operating system, Windows operating system, Bade operating system and Symbian operating system.

Moreover, the portable communication device 104 includes an internet facility. In an embodiment of the present disclosure, the portable communication device 104 is presently connected to the internet. In an embodiment of the present disclosure, the portable communication device 104 is connected to the internet through a WiFi connection. In another embodiment of the present disclosure, the portable communication device 104 is connected to the internet through a data connection provided by a telecom service provider. In an embodiment of the present disclosure, the portable communication device 104 is connected to an internet broadband system, a local area network, a wide area network, a digital or analog cable television network or any other communication network presently known in the art. The internet broadband system maybe a wired or a wireless system.

In an embodiment of the present disclosure, the portable communication device 104 includes one or more browsers 104a pre-installed in the portable communication device 104. The one or more browsers 104a enable the user 102 to access the internet. In an embodiment of the present disclosure, the user 102 accesses the portable communication device 104 for accessing a publisher of the one or more publishers 106 on a browser of the one or more browsers. In an embodiment of the present disclosure, the user 102 accesses one or more websites of the corresponding one or more publishers 106 for accessing any content. In an embodiment of the present disclosure, the website accessed by the user 102 on the portable communication device 104 may show content related to interests of the user 102.

Examples of the one or more browsers 104a include google chrome, internet explorer, Mozilla firefox, opera mini or any other browser for accessing the one or more publishers known in the art. Further, the content accessed by the user 102 on the corresponding one or more browsers 104a include one or more sports content, one or more news content, one or more movies content, one or more e-commerce content and the like. The one or more browsers 104a allow the user 102 to access the one or more websites based on his/her choice. The one or more websites are associated with the one or more publishers 106 hosting the one or more websites on the web.

Moreover, the one or more websites display the one or more content for the user 102. In addition, the one or more content may be an audio content, an audio-video content, a video content, a text content and the like. In an embodiment of the present disclosure, the one or more websites include an e-commerce website, a social networking website, a news website, a blog, photo sharing website or any other type of website providing the one or more content to the user 102.

Further, the one or more publishers 106 correspond to one or more website owners for providing content to the user 102 of the one or more users. Furthermore, the one or more publishers 106 provide the one or more users with a single type of content or a multiple type of content. The type of content includes one or more video content, one or more audio content, one or more text content, one or more audio-video content and the like. Moreover, each of the one or more publishers 106 is associated with a specific category of publishers. Examples of the one or more publishers 106 include but may not be limited to Amazon, jabong, myntra, fashionandyou, dailymotion, flipkart and snapdeal. In an embodiment of the present disclosure, the publisher of the one or more publishers 106 accessed by the user 102 corresponds to an e-commerce publisher.

Going further, the one or more publishers 106 provide space, areas or a part of their web pages for advertising purposes. These areas or spaces on the web pages are referred to as advertisement slots. The web page can have the various advertisement slots depending on choice of each of the one or more publishers 106. The one or more publishers 106 advertise products, services or businesses to the one or more users for generating revenue. It may be noted that the term publisher in context of the present application may be referred to as publisher website which may have advertisement slots for advertising. In an embodiment of the present disclosure, the term publisher in context of the present application may be referred to as a mobile application or a mobile website which may have the advertisement slots for advertising.

In an embodiment of the present disclosure, the one or more publishers 106 display the one or more advertisements on the corresponding advertisement slots in the web pages of the one or more publishers 106. In an embodiment of the present disclosure, the one or more publishers 106 display the one or more advertisements when the user 102 requests for the content to be displayed on the one or more publishers 106 website. In an embodiment of the present disclosure, the one or more advertisements are displayed for generating revenue based on number of impressions, number of clicks, number of installs or other one or more actions taken by the one or more users on viewing or encountering the one or more advertisements. In an embodiment of the present disclosure, the one or more advertisements are displayed during viewing of the content. For example, a user A encounter an advertisement while viewing one or more products on a publisher (say, Amazon). In another embodiment of the present disclosure, the one or more advertisements are displayed along with the content viewed by the user 102 of the one or more users in the corresponding one or more advertisement slots on the one or more publishers 106.

Moreover, the one or more publishers 106 include one or more tags 106a on each webpage of the plurality of web pages associated with each of the one or more publishers 106. The one or more tags 106a correspond to one or more ad tags contained in code of the web page. The one or more tags 106a correspond to a unique and small piece of code. In addition, the one or more tags 106a are embedded in the web pages of the one or more publishers for advertising purposes. In an embodiment of the present disclosure, the one or more tags 106a are executed based on some pre-defined rules (as explained later in the patent application).

In an embodiment of the present disclosure, the one or more publishers 106 request for webpage content from a web server associated with the one or more publishers 106 when the user 102 loads the web page of the corresponding one or more publishers 106. Moreover, the web server provides the web page content along with the one or more tags 106a. In an embodiment of the present disclosure, the one or more tags 106a are pre-stored in the web server. In an embodiment of the present disclosure, each of the one or more tags 106a are contained in a master tag known as a container tag. The container tag executes each of the one or more tags 106a based on a pre-defined events (as explained in detail below in the patent application).

In an embodiment of the present disclosure, the one or more tags 106a are executed based on one or more actions taken by the user 102 on the corresponding publisher of the one or more publishers 106. In addition, each of the one or more tags 106a is made based on a corresponding rule for execution in real time. In an embodiment of the present disclosure, the one or more tags 106a enable the one or more publishers 106 to collect information associated with the user 102 of the one or more users. The information includes a browsing history, behavioral information, interests of the user 102 and the like. In an embodiment of the present disclosure, the one or more tags 106a are provided to the one or more publishers 106 by advertisement supplying intermediaries. The advertisement supplying intermediaries include advertisement networks, advertisement exchanges, advertisement agencies and the like.

In another embodiment of the present disclosure, the one or more tags 106a are provided by the advertisement tag management system 112 to the one or more publishers 106 in real time. In an embodiment of the present disclosure, each of the one or more tags 106a is associated with a correspond advertisement slot of the one or more advertisement slots for displaying an advertisement of the one or more advertisements on the corresponding advertisement slot of the one or more advertisement slots when the corresponding tag of the one or more tags 106a is executed. Moreover, the one or more publishers 106 are associated with the one or more advertisers 108. In addition, the one or more advertisers 108 provide advertisements to the one or more publishers 106 for displaying on their website or application. The advertisements are placed on the advertisement slots on the website or the application.

Further, the one or more advertisers 108 purchase the one or more advertisement slots from the one or more publishers 106. In an embodiment of the present disclosure, the one or more advertisers 108 purchase the advertisement slots for displaying the one or more advertisements on the corresponding advertisement slots for generating revenue based on the number of impressions, the number of clicks, the number of installs or other one or more actions taken by the one or more users on viewing the corresponding one or more advertisements on the one or more publishers 106. Moreover, the one or more advertisers 108 provide the one or more advertisements to the one or more publishers 106 in real time.

In an embodiment of the present disclosure, the one or more advertisements displayed are associated with the interests of the user 102. In an embodiment of the present disclosure, the one or more advertisements correspond to a content viewing history of the one or more users for attracting more number of clicks from the one or more users in order to increase the revenue generation. Going further, the one or more advertisers 108 and the one or more publishers 104 are associated through one or more advertisement supplying intermediaries.

Moreover, the advertisement supplying intermediaries enables a connection or link between the one or more publishers 106 and the one or more advertisers 108. In an embodiment of the present disclosure, the advertisement supplying intermediaries works as a third party medium for efficient buying and selling of the one or more advertisement slots. In an embodiment of the present disclosure, the advertisement supplying intermediaries is a platform for buying and selling of advertisement inventory between the one or more publishers 106 and the one or more advertisers 108. In an embodiment of the present disclosure, the advertisement supplying intermediaries deal with the one or more publishers 106 and the one or more advertisers 108 through a mutual contract for defining terms and conditions associated with revenue.

In an embodiment of the present disclosure, each tag of the one or more tags 106a is associated with a corresponding advertiser of the one or more advertisers 108. In an embodiment of the present disclosure, the advertiser of the one or more advertisers 108 may be associated with more than one tag of the one or more tags 106a based on a number of rules for the corresponding advertiser of the one or more advertisers 108. In addition, each of the one or more advertisers 108 provides one or more conditions in order to execute their tags of the one or more tags 106a. Moreover, the one or more conditions are provided based on one or more advertisement campaigns run by the one or more advertisers 108. In an embodiment of the present disclosure, the one or more conditions correspond to one or more campaign goals associated with each of the one or more advertisers 108.

In an embodiment of the present disclosure, the advertisement supplying intermediaries run the one or more advertisement campaigns on behalf of the one or more advertisers 108. In an embodiment of the present disclosure, the advertisement supplying intermediaries specify the one or more conditions for the one or more advertisers 108 on their behalf based on properties of the one or more advertisement campaigns for executing their tags. In an embodiment of the present disclosure, the one or more advertisers 108 provide the one or more conditions through the advertisement tag management system 112.

In an embodiment of the present disclosure, the one or more publishers 106 and the one or more advertisers 108 generate revenue by providing and displaying the one or more advertisements based on a compensation method. In addition, the compensation method includes but may not be limited to a pay per click, pay per action, cost per thousand impressions and cost per view.

Going further, the portable communication device 104 is associated with the communication network 110. In an embodiment of the present disclosure, the portable communication device 104 is associated with the one or more publishers 106 and the one or more advertisers 108 through the communication network 110. In an embodiment of the present disclosure, the one or more publishers 106 are associated with the one or more advertisers 108 through the communication network 110. In an embodiment of the present disclosure, the advertisement supplying intermediaries is associated with the one or more publishers 106 and the one or more advertisers 108 through the communication network 110.

In addition, the communication network 110 enables the portable communication device 104 to connect to the internet. In an embodiment of the present disclosure, the user 102 accesses the one or more publishers 106 on the corresponding portable communication device 104 through the communication network 110. Further, the medium for communication may be infrared, microwave, radio frequency (RF) and the like. The communication network 110 include but may not be limited to a local area network, a metropolitan area network, a wide area network, a virtual private network, a global area network, a home area network or any other communication network presently known in the art. The communication network 110 is a structure of various nodes or communication devices connected to each other through a network topology method. Examples of the network topology include a bus topology, a star topology, a mesh topology and the like.

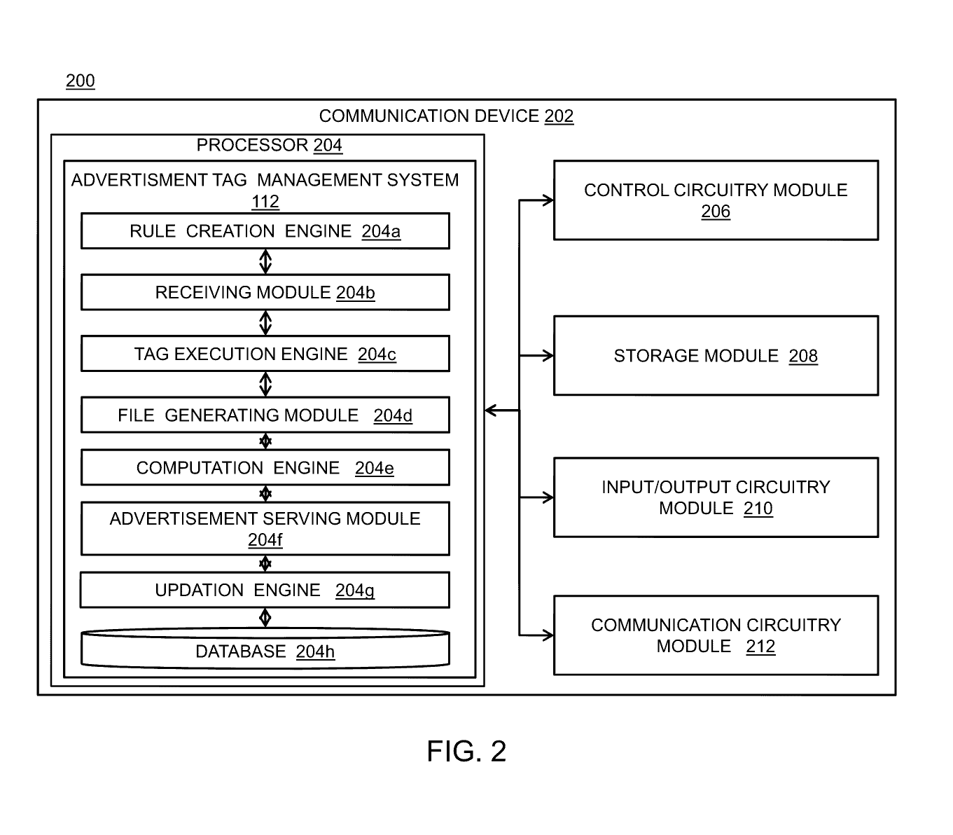

Going further, the one or more publishers 106 and the one or more advertisers 108 are associated with the advertisement tag management system 112. In an embodiment of the present disclosure, the one or more publishers 106 and the one or more advertisers 108 are associated with the advertisement tag management system 112 through the communication network 110. Moreover, the advertisement tag management system 112 performs the managing of the plurality of tag embedded on the web pages of the one or more publishers 106 for serving the one or more advertisements to the one or more users in real time. The advertisement tag management system 112 enables the execution of each of the plurality of tags based on a pre-determined criterion (as mentioned below in the detailed description of FIG. 2). In an embodiment of the present disclosure, the advertisement tag management system 112 is a part of the advertisement supplying intermediaries for managing the plurality of tags and serving of the one or more advertisements to the one or more users in real time.

Further, the advertisement tag management system 112 is configured for defining or creating one or more rules 112a for each of the one or more tags 106a embedded in each of the plurality of web pages. Furthermore, the advertisement tag management system 112 performs one or more operations based on the defined one or more rules 112a (as stated below in the detailed description of FIG. 2). Moreover, the advertisement tag management system 112 is configured to receive a first set of information associated with the user 102 of the one or more users accessing the publisher of the one or more publishers 106 in real time. In addition, the advertisement tag management system 112 utilizes the first set of information for performing serving of the one or more advertisements to the user 102 of the one or more users in real time (as described below in the patent application).

Further, the advertisement tag management system 112 is configured to execute each of the one or more tags 106a based on the one or more rules 112a defined for each of the one or more tags 106a and the first set of information associated with the user 102 of the one or more users (as mentioned below in the detailed description of FIG. 2). In addition, the advertisement tag management system 112 is configured to serve the one or more advertisements to the user 102 of the one or more users on the corresponding publisher of the one or more publishers 106 in real time based on a pre-determined criterion (as illustrated below in the patent application).

Going further, the one or more publishers 106, the one or more advertisers 108 and the advertisement tag management system 112 are associated with the ad server 114. In an embodiment of the present disclosure, the one or more publishers 106, the one or more advertisers 108 and the advertisement tag management system 112 are associated with the ad server 114 through the communication network 112. Moreover, the ad server 114 is configured to provide the one or more advertisements to the one or more publishers 106 in real time based on a request by the one or more publishers 106. In an embodiment of the present disclosure, the ad server 114 is linked a server associated with the one or more publishers 106 and a server associated with the one or more advertisers 108. In an embodiment of the present disclosure, the ad server 114 is a part of the advertisement tag management system 112 for providing advertisements in real time based on the request by the advertisement tag management system 112. In an embodiment of the present disclosure, the ad server 114 is a third party ad server. In an embodiment of the present disclosure, the ad server 114 stores the one or more advertisements for the one or more advertisers 108.

It may be noted that in FIG. 1A, the user 102 is associated with the portable communication device 104; however those skilled in the art would appreciate that there are more number of users associated with more number of portable communication devices. For example, a user X, a user Y and a user Z are associated with a communication device D1, a communication device D2 and a communication device D3. It may also be noted that in FIG. 1A, the user 102 accesses the one or more publishers 106 on the corresponding portable communication device 104; however those skilled in the art would appreciate that there more number users accessing the one or more publishers 106 on more number of portable communication devices. It may be noted that in FIG. 1A, the ad server 114 is associated with the one or more publishers 106 and the one or more advertisers 108; however those skilled in the art would appreciate that there are more number of ad servers associated with the one or more publishers 106 and the one or more advertisers 108.

In an embodiment of the present disclosure, as illustrated in FIG. 1B, the advertisement tag management system 112 is part of the one or more publishers 106. In an embodiment of the present disclosure, the one or more publishers 106 include the advertisement tag management system 112. In an embodiment of the present disclosure, the advertisement tag management system 112 is located on a backend of each of the one or more publishers 106. In an embodiment of the present disclosure, the one or more publishers 106 are registered on the advertisement tag management system 112. In another embodiment of the present disclosure, the one or more publishers 106 have an account on the advertisement tag management system 112. In an embodiment of the present disclosure, the advertisement tag management system 112 provides a web-based interface for the one or more publishers 106. In an embodiment of the present disclosure, the one or more advertisers 108 have an account on the advertisement tag management system 112. In an embodiment of the present disclosure, the one or more publishers 106 enable the one or more advertisers to utilize the web-based interface for providing the one or more conditions and the one or more tags 106a.

Going further, in an embodiment of the present disclosure, the one or more publishers 106 register on the advertisement tag management system 112 by paying some pre-defined amount of money in order to avail one or more services offered by the advertisement tag management system 112. In an embodiment of the present disclosure, the advertisement tag management system 112 may accept multiple forms of payment to fund the account, such as electronic transfer (e.g., automated clearing house (ACH) transfer or wire transfer) from a designated bank account, credit card (e.g., Visa, MasterCard, Discover, American Express), online wallet (e.g., PayPal, Amazon Payments and Google Checkout) and/or mobile payment.

In an embodiment of the present disclosure, the advertisement tag management system 112 enables the one or more publishers 106 to download one or more comprehensive reports associated with the one or more advertisements and the one or more tags 106a associated with the one or more advertisers 108.

FIG. 2 illustrates a block diagram 200 of a communication device 202, in accordance with various embodiments of the present disclosure. The communication device 202 includes a processor 204, a control circuitry module 206, a storage module 208, an input/output circuitry module 210 and a communication circuitry module 212. In an embodiment of the present disclosure, the processor 204 includes one or more components of the advertisement tag management system 112. Further, the one or more components of the advertisement serving optimization system 112 in the processer 204 includes a rule creation engine 204a, a receiving module 204b, a tag execution engine 204c, a file generating module 204d, a computation engine 204e, an advertisement serving module 204f, an updation engine 204g and a database 204h.

It may be noted that to explain the system elements of FIG. 2, references will be made to the system elements of FIG. 1A and FIG. 1B. In an embodiment of the present disclosure, the processor 204 enables the working of the advertisement tag management system 112 for the managing of the plurality of tags embedded on the web pages of the one or more publishers 106 and serving the one or more advertisements to the one or more users on the corresponding one or more publishers 106. In an embodiment of the present disclosure, the one or more components of the advertisement tag management system 112 enables the managing of the plurality of tags embedded on the web pages of the one or more publishers 106 and serving the one or more advertisements to the one or more users on the corresponding one or more publishers 106. In an embodiment of the present of the disclosure, the communication device 202 enables the hosting of the advertisement tag management system 112.

Going further, the user 102 accesses the publisher of the one or more publishers 106 on the browser of the one or more browsers 104a for accessing any content of his/her choice. The one or more publishers 106 provide or display the content to the user 102 by requesting the web content from the web server in real time. The user 102 views the content on the portable communication device 104 in real time. In addition, the rule creation engine 204a in the processor 204 is configured to define a plurality of rules for each of the plurality of tags embedded in each of the plurality of web pages on the corresponding one or more publishers. In an embodiment of the present disclosure, the plurality of rules is pre-defined by the advertisement tag management system 112. In an embodiment of the present disclosure, the plurality of rules is created in real time. In an embodiment of the present disclosure, the plurality of rules is created for each of the plurality of tags.

In addition, the plurality of rules is defined based on a pre-determined criterion. Moreover, the pre-determined criterion includes one or more advertiser conditions provided by the one or more advertisers 108 for the execution of each of the plurality of tags. In an embodiment of the present disclosure, each of the one or more advertisers 108 is associated with a corresponding tag of the plurality of tags. In an embodiment of the present disclosure, each of the one or more advertiser conditions is provided for targeting a specific group of users for serving the advertisements.

In an embodiment of the present disclosure, the one or more advertiser conditions correspond to one or more specific events taking place on the one or more publishers 106 for triggering the execution of the corresponding tag of the plurality of tags contained in the container tag on the web page of the corresponding one or more publishers 106. In an embodiment of the present disclosure, each rule of the plurality of rules is defined for execution of a corresponding tag of the plurality of tags. Moreover, each of the plurality of rules is defined by the one or more advertisers 108. Further, each rule of the plurality of rules is created based on an event type.

Furthermore, the event type is a function of one or more pre-defined matching techniques. In an embodiment of the present disclosure, the one or more pre-defined matching techniques include but may not be limited to an exact match, no match, regular expression matching and conditional parameters matching. In an embodiment of the present disclosure, the one or more pre-defined matching techniques are utilized for executing the relevant tag of the plurality of tags and serving the corresponding relevant advertisement of the one or more advertisements.

In an embodiment of the present disclosure, the one or more pre-defined matching techniques perform matching based on a specific action taken by the user 102 of the one or more users on the corresponding website of the one or more publishers 106 for determining the relevant tag of the plurality of tags which is to be fired or executed. In an embodiment of the present disclosure, the matching is done for determining the rule of the plurality of rules which is to be executed. In an embodiment of the present disclosure, a type of the plurality of rules includes but may not be limited to a url rule, a variable rule and a cookie rule.

For example, a user X accesses a website of a publisher P1 (say, Amazon.com) through a browser B1 of a portable communication device D1 (say, a laptop) and a user Y accesses a website of a publisher P2 (say, flipkart.com) through a browser B2 of a portable communication device D2. The publisher P1 includes one or more tags T (say T1, T2, T3, T4, T5, T6 and T7) embedded on a web page of the publisher P1 and the publisher P2 includes one or more tags U (say U1, U2, U3, U4, U5 and U6). The one or more tags T (T1, T2, T3, T4, T5, T6 and T7) correspond to one or more advertisers A (say, A1, A2, A3, A4, A5, A6 and A7) and the one or more tags U (U1, U2, U3, U4, U5 and U6) correspond to one or more advertisers G (say, G1, G2, G3, G4, G5 and G6). The rule creation module 204a creates a plurality of rules R (say R1, R2, R3, R4, R5, R6 and R7) for the corresponding one or more tags T (T1, T2, T3, T4, T5, T6 and T7) and a plurality of rules L (say L1, L2, L3, L4, L5 and L6) for the corresponding one or more tags U (U1, U2, U3, U4, U5 and U6). Each of the plurality of rules R is based on conditions provided by the corresponding advertisers A and each of the plurality of rules L is based on conditions provided by the corresponding advertisers G.

Going further, the receiving module 204b in the processor 204 is configured to receive the first set of information associated with one or more event types on the corresponding one or more publishers 106. In addition, the one or more event types corresponds to a specific set of pre-defined actions taken by the user 102 of the one or more users on the corresponding one or more publishers 106 containing the plurality of tags. Moreover, the first set of information is received in real time. In an embodiment of the present disclosure, the advertisement tag management system 112 records the behavior of the user 102 of the one or more users and tracks online activity of the user 102 in real time.

In an embodiment of the present disclosure, the tracking is done for determining a current action taken by the user 102 on the publisher of the one or more publishers 106. In an embodiment of the present disclosure, the specific set of pre-defined actions include a purchase done by the user 102 on the corresponding publisher of the one or more publishers 106, one or more specific products purchased by the user 102 on the corresponding publisher of the one or more publishers 106, a specific set of products viewed by the user 102 on the corresponding publisher of the one or more publishers 106, a specific category of products viewed by the user 102, a specific threshold amount of purchase made by the user 102 on the corresponding publisher of the one or more publishers 106 and the like.

In an embodiment of the present disclosure, the specific set of pre-defined actions is correlated with the one or more advertiser conditions provided by the one or more advertisers 108. In an embodiment of the present disclosure, the specific set of pre-defined actions is provided by the one or more advertisers 108. In an embodiment of the present disclosure, the tracking is done by utilizing information from one or more cookies associated with the corresponding publisher of the one or more publishers 106 and extracting data from the one or more cookies for determining the one or more event types on the corresponding publisher of the one or more publishers 106. Continuing the above stated example, the user X makes a purchase of more than 2000 rupees on the publisher P1 and the user Y makes a purchase of one or more clothing products for an amount of 5000 rupees on the publisher P2. The receiving module 204b receives the first set of information (the user X makes purchase of more than 2000 rupees and the user Y makes a purchase of 5000 rupees for the clothing products).

Going further, the tag execution engine 204c in the processor 204 is configured to execute each of the plurality of tags based on the pre-determined criterion. In an embodiment of the present disclosure, the tag execution engine 204c executes each of the plurality of tags based on the one or more advertiser conditions and the one or more event types on the corresponding publisher of the one or more publishers 106 in real time. In addition, each of the plurality of tags is executed based on the corresponding plurality of rules defined for each of the plurality of tags. Moreover, a specific tag of the plurality of tags is executed on execution of a rule of the plurality of rules corresponding to the specific tag. Further, the execution of each of the plurality of tags is based on the received first set of information.

In an embodiment of the present disclosure, the execution of each of the plurality of tags corresponds to firing of each of the plurality of tags. In an embodiment of the present disclosure, the plurality of tags is fired or executed based on a matching between an advertiser condition of the one or more advertiser conditions associated with the advertiser of the one or more advertisers 108 and a specific event type of the one or more event types for firing or executing the relevant tag of the plurality of tags. In an embodiment of the present disclosure, the tag execution engine 204c may execute more than one tag at the same time based on a subset of the one or more event types taking place on the corresponding publisher of the one or more publisher 106.

In an embodiment of the present disclosure, the execution of each of the plurality of tags is done based on a matching process. Moreover, the matching process matches the one or more advertiser conditions provided by the one or more advertisers 108 with the one or more event types on the corresponding one or more publishers 106. In an embodiment of the present disclosure, the matching is done for the execution of a relevant tag defined based on a matched advertiser condition of the one or more advertiser conditions.

In an embodiment of the present disclosure, the tag execution engine 204c executes the plurality of tags each time the user 102 takes some action on the corresponding publisher of the one or more publishers 106. The action is matched against the one or more advertiser conditions for executing the relevant tag of the plurality of tags. In an embodiment of the present disclosure, each of the plurality of tags includes one or more tag supports. The one or more tag supports include but may not be limited to a platform level tag, a third party HTML tag and a third party URL tag. Going further, the file generating module 204d in the processor 204 is configured to generate a file based on changes in each of the plurality of tags. In an embodiment of the present disclosure, the file is generated each time a tag of the plurality of tags is fired or executed on the corresponding publisher of the one or more publishers 106.

Moreover, the file is generated for recording the tag of the plurality of tags which is executed and the advertiser of the one or more advertisers 108 corresponding to the executed tag of the plurality of tags. In an embodiment of the present disclosure, the file is created for storing information about the advertiser of the one or more advertisers 108 whose tag is executed on the corresponding publisher of the one or more publishers 106. Moreover, the file is created for each of the plurality of tags. In addition, the file is generated for determining the specific tag of the plurality of tags on the corresponding one or more publishers to be executed.

Further, the generated file is dynamically pushed to a server. In an embodiment of the present disclosure, the server is remotely located from the portable communication device 104. In an embodiment of the present disclosure, the server is associated with the one or more publishers 106. In another embodiment of the present disclosure, the server is associated with the one or more advertisers 108. In yet another embodiment of the present disclosure, the server is associated with the advertisement tag management system 112. In yet another embodiment of the present disclosure, the server corresponds to the ad server 114.

In an embodiment of the present disclosure, the advertisement tag management system 112 transmits the file to the ad server 114. In an embodiment of the present disclosure, a new file is generated each time the tag of the plurality of tags is executed on the corresponding publisher of the one or more publishers 106. In an embodiment of the present disclosure, the file is a Javascript file. Moreover, the Javascript file is updated each time based on the changes in the container tag.

Extending the above stated example, the tag T3 of the one or more tags T on the publisher P1 corresponds to a condition set by the advertiser A3 of the one or more advertisers A. The condition is that the tag T3 will be fired when a user (the user X) makes a purchase of more than 2000 rupees. Similarly, the tag U5 of the one or more tags U on the publisher P2 corresponds to a condition set by the advertiser G5 of the one or more advertisers G. The condition is that the tag U5 will be fired when a user (the user Y) buys clothing products for an amount greater than 4000 rupees. Since the user X performed an action which corresponds to the rule R3 of the plurality of rules R and the user Y performed an action which corresponds to the rule L5 of the plurality of rules L. The tag execution engine 204c executes the tag T3 on the corresponding publisher P1 based on the condition of the advertiser A3 and the tag U5 on the corresponding publisher P2 based on the condition of the advertiser G5. Moreover, the file generating module 204d generates a file F1 for the corresponding tag T3 and a file F2 for the corresponding tag U5 and transmits it to a server Z.

Going further, the computation engine 204e in the processor 204 is configured to analyze the generated file for determining the corresponding executed tag of the plurality of tags. In an embodiment of the present disclosure, the computation engine 204e computes information associated with the tag of the plurality of tags which has been executed currently by the tag execution engine 204c. In an embodiment of the present disclosure, the computation engine 204e passes on the information to the ad server 114 for further operations. In another embodiment of the present disclosure, the computation engine passes on the information to the content delivery network.

In an embodiment of the present disclosure, the analyzing is done for recognizing the advertiser of the one or more advertisers 108 associated with the corresponding executed tag of the plurality of tags. In an embodiment of the present disclosure, the advertiser is recognized by matching against a list of advertisers and the corresponding tags of the plurality of tags.

Moreover, the advertisement serving module 204f in the processor 204 is configured to display an advertisement of the one or more advertisements to the user 102 of the one or more users on a corresponding advertisement slot of the one or more advertisement slots associated with the corresponding publisher of the one or more publishers 106 based on the computation. In addition, the advertisement of the one or more advertisements is associated with the advertiser of the one or more advertisers 108 associated with the corresponding tag of the plurality of tags executed in real time.

In an embodiment of the present disclosure, the advertisement serving module 204f displays more than one advertisement to the user 102 of the one or more users on a corresponding advertisement slots based on a number of tags of the plurality of tags fired or executed in real time. In an embodiment of the present disclosure, the one or more advertisements are based on the interests of the user 102. The one or more advertisements are displayed corresponding to the executed tag and the advertiser of the one or more advertisers 108 associated with the corresponding executed tag.

In an embodiment of the present disclosure, the advertisement serving module 204f receives the advertisement of the one or more advertisements from the ad server 114 in real time. In an embodiment of the present disclosure, the advertisement serving module 204f requests the ad server 114 to provide the advertisement of the one or more advertisements corresponding to the tag of the plurality of tags executed in real time. In addition, the one or more advertisements include banner advertisements, video advertisements, audio advertisements, audio video advertisements and the like. In an embodiment of the present disclosure, the one or more advertisements include product related advertisements.

Continuing the above stated example, the advertisement serving module 204f displays an advertisement F1 corresponding to the advertiser A3 and the associated tag T3 on an advertisement slot S1 of the corresponding publisher P1. Similarly, the advertisement serving module 204f displays an advertisement F2 corresponding to the advertiser G5 and the associated tag U5 on an advertisement slot S2 of the corresponding publisher P2.

Going further, the updation engine 204g in the processor 204 is configured to dynamically update each of the plurality of rules based on the pre-determined criterion, the first set of information associated with the one or more event types and a content corresponding to the generated file. In an embodiment of the present disclosure, the updation is done each time the tag of the plurality of tags is executed in real time. In an embodiment of the present disclosure, the updation is performed for providing information for displaying the one or more advertisements which are relevant for the user 102.

Moreover, the database 204h in the processor 204 is configured for storing the plurality of rules, the plurality of tags, the first set of information associated with the one or more event types, information associated with the execution of each of the plurality of tags, the one or more advertiser conditions and information associated with the one or more users. In an embodiment of the present disclosure, the stored information in the database 204h is regularly updated in real time.

It may be noted that in FIG. 2, various modules of the advertisement tag management system 112 are shown that illustrates the working of the advertisement serving optimization system 112; however those skilled in the art would appreciate that the advertisement tag management system 112 may have more number of modules that could illustrate overall functioning of the advertisement tag management system 112.

Going further, the communication device 202 includes any suitable type of portable electronic device. Examples of the communication device 202 include but may not be limited to a personal e-mail device (e.g., a Blackberry™ made available by Research in Motion of Waterloo, Ontario), a personal data assistant (“PDA”), a cellular telephone, a Smartphone, the laptop computer, and the tablet computer. In another embodiment of the present disclosure, the communication device 202 can be a desktop computer.

From the perspective of this disclosure, the control circuitry module 206 includes any processing circuitry or processor operative to control the operations and performance of the communication device 202. For example, the control circuitry module 206 may be used to run operating system applications, firmware applications, media playback applications, media editing applications, or any other application. In an embodiment, the control circuitry module 206 drives a display and process inputs received from the user interface. From the perspective of this disclosure, the storage module 208 includes one or more storage mediums including a hard-drive, solid state drive, flash memory, permanent memory such as ROM, any other suitable type of storage component, or any combination thereof. The storage module 208 may store, for example, media data (e.g., music and video files), application data (e.g., for implementing functions on the communication device 202).

From the perspective of this disclosure, the I/O circuitry module 210 may be operative to convert (and encode/decode, if necessary) analog signals and other signals into digital data. In an embodiment, the I/O circuitry module 210 may also convert the digital data into any other type of signal and vice-versa. For example, the I/O circuitry module 210 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 206, the storage module 208 or any other component of the communication device 202. It may be noted that the I/O circuitry module 210 is illustrated in FIG. 2 as a single component of the communication device 202; however those skilled in the art would appreciate that several instances of the I/O circuitry module 210 may be included in the communication device 202.

The communication device 202 may include any suitable interface or component for allowing the user 102 to provide inputs to the I/O circuitry module 210. The communication device 202 may include any suitable input mechanism. Examples of the input mechanism include but may not be limited to a button, keypad, dial, a click wheel, and a touch screen. In an embodiment, the communication device 202 may include a capacitive sensing mechanism, or a multi-touch capacitive sensing mechanism. In an embodiment, the communication device 202 may include specialized output circuitry associated with output devices such as, for example, one or more audio outputs. The audio output may include one or more speakers built into the communication device 202, or an audio component that may be remotely coupled to the communication device 202.

The one or more speakers can be mono speakers, stereo speakers, or a combination of both. The audio component can be a headset, headphones or ear buds that may be coupled to the communication device 202 with a wire or wirelessly. In an embodiment, the I/O circuitry module 210 may include display circuitry for providing a display visible to the user 102. For example, the display circuitry may include a screen (e.g., an LCD screen) that is incorporated in the communication device 202. The display circuitry may include a movable display or a projecting system for providing a display of content on a surface remote from the communication device 202 (e.g., a video projector). In an embodiment, the display circuitry may include a coder/decoder to convert digital media data into the analog signals. For example, the display circuitry may include video Codecs, audio Codecs, or any other suitable type of Codec.

The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 206. Alternatively, the display circuitry may be operative to provide instructions to a remote display. In addition, the communication device 202 includes the communication circuitry module 212. The communication circuitry module 212 may include any suitable communication circuitry operative to connect to a communication network and to transmit communications (e.g., voice or data) from the communication device 202 to other devices within the communications network. The communication circuitry module 212 may be operative to interface with the communication network using any suitable communication protocol. Examples of the communication protocol include but may not be limited to Wi-Fi, Bluetooth®, radio frequency systems, infrared, LTE, GSM, GSM plus EDGE, CDMA, and quadband.

In an embodiment, the communication circuitry module 212 may be operative to create a communications network using any suitable communications protocol. For example, the communication circuitry module 212 may create a short-range communication network using a short-range communications protocol to connect to other devices. For example, the communication circuitry module 212 may be operative to create a local communication network using the Bluetooth®, protocol to couple the communication device 202 with a Bluetooth®, headset.

It may be noted that the computing device is shown to have only one communication operation; however, those skilled in the art would appreciate that the communication device 202 may include one more instances of the communication circuitry module 212 for simultaneously performing several communication operations using different communication networks. For example, the communication device 202 may include a first instance of the communication circuitry module 212 for communicating over a cellular network, and a second instance of the communication circuitry module 212 for communicating over Wi-Fi or using Bluetooth®.

In an embodiment of the present disclosure, the same instance of the communication circuitry module 212 may be operative to provide for communications over several communication networks. In an embodiment, the communication device 202 may be coupled to a host device for data transfers, syncing the communication device 202, software or firmware updates, providing performance information to a remote source (e.g., providing riding characteristics to a remote server) or performing any other suitable operation that may require the communication device 202 to be coupled to the host device. Several computing devices may be coupled to a single host device using the host device as a server. Alternatively or additionally, the communication device 202 may be coupled to the several host devices (e.g., for each of the plurality of the host devices to serve as a backup for data stored in the communication device 202).

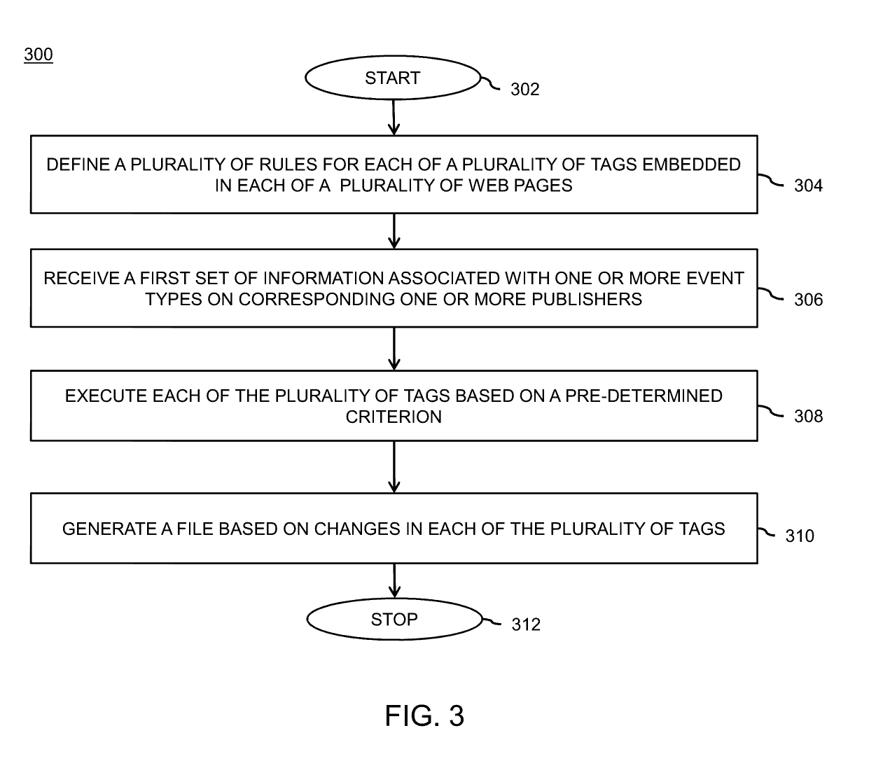

FIG. 3 illustrates a flowchart 300 for enabling management of the plurality of tags embedded on the plurality of web pages associated with the one or more publishers, in accordance with various embodiments of the present disclosure. It may be noted that to explain the process steps of the flowchart 300, references will be made to the system elements of the FIG. 1A, FIG. 1B and FIG. 2. The flowchart 300 initiates at step 302. At step 304, the rule creation engine 204a defines the plurality of rules for each of the plurality of tags embedded on the plurality of web pages associated with each of the one or more publishers 106. Each of the plurality of rules is defined based on the pre-determined criterion and each rule of the plurality of rules is defined for the execution of the corresponding tag of the plurality of tags. Also, each of the plurality of rules is defined by the one or more advertisers 108. At step 306, the receiving module 204b receives the first set of information associated with the one or more event types on the corresponding one or more publishers 106. The one or more event types corresponds to the specific set of pre-defined actions taken by the one or more users on the corresponding one or more publishers 106 containing the plurality of tags. At step 308, the tag execution engine 204c executes each of the plurality of tags based on the pre-determined criterion. Each of the plurality of tags is executed based on the corresponding plurality of rules defined for each of the plurality of tags. In addition, the specific tag of the plurality of tags is executed on the execution of the rule of the plurality of rules corresponding to the specific tag. At step 310, the file generating module 204d generates the file based on changes in each of the plurality of tags. The file is created for each of the plurality of tags and the file is generated for determining the specific tag of the plurality of tags executed on the corresponding one or more publishers 106. The flowchart 300 terminates at step 312.

It may be noted that the flowchart 300 is explained to have above stated process steps; however, those skilled in the art would appreciate that the flowchart 300 may have more/less number of process steps which may enable all the above stated embodiments of the present disclosure.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A computer-implemented method for enabling management of a plurality of tags embedded on a plurality of web pages associated with one or more publishers, the computer-implemented method comprising:
defining, with a processor, a plurality of rules for each of the plurality of tags embedded in each of the plurality of web pages, wherein each of the plurality of rules being defined based on a pre-determined criterion, wherein each rule of the plurality of rules being defined for execution of a corresponding tag of the plurality of tags, wherein each of the plurality of rules being defined by one or more advertisers and wherein each of the plurality of rules being created based on an event type and wherein each of the plurality of tags being contained in a tag container;
receiving, with the processor, a first set of information associated with one or more event types on the corresponding one or more publishers, wherein the one or more event types corresponds to a specific set of pre-defined actions taken by one or more users on the corresponding one or more publishers containing the plurality of tags and wherein the first set of information being received in real time;
executing, with the processor, each of the plurality of tags based on the pre-determined criterion, wherein each of the plurality of tags being executed based on the corresponding plurality of rules defined for each of the plurality of tags, wherein a specific tag of the plurality of tags being executed on execution of the rule of the plurality of rules corresponding to the specific tag and wherein the execution of each of the plurality of tags being based on the received first set of information; and
generating, with the processor, a file based on changes in each of the plurality of tags, wherein the file being created for each of the plurality of tags, wherein the file being generated for determining the specific tag of the plurality of tags executed on the corresponding one or more publishers and wherein the generated file being dynamically pushed to a server.

2. The computer-implemented method as recited in claim 1, further comprising dynamically updating, with the processor, each of the plurality of rules based on the pre-determined criterion, the first set of information associated with the one or more event types and a content corresponding to the generated file.

3. The computer-implemented method as recited in claim 1, wherein the pre-determined criterion comprises one or more advertiser conditions provided by the one or more advertisers for the execution of each of the plurality of tags, wherein each of the one or more advertisers being associated with the corresponding tag of the plurality of tags and wherein each of the one or more advertiser conditions being provided for targeting a specific group of users for serving one or more advertisements.

4. The computer-implemented method as recited in claim 1, further comprising analyzing, with the processor, the generated file for determining the corresponding executed tag of the plurality of tags, wherein the analyzing being done for recognizing an advertiser of the one or more advertisers associated with the corresponding executed tag of the plurality of tags.

5. The computer-implemented method as recited in claim 1, further comprising displaying, with the processor, an advertisement of the one or more advertisements to a user of the one or more users on a corresponding advertisement slot of one or more advertisement slots associated with a corresponding publisher of the one or more publishers based on the computation, wherein the advertisement of the one or more advertisements being associated with the advertiser of the one or more advertisers associated with the corresponding tag of the plurality of tags being executed in real time.

6. The computer-implemented method as recited in claim 1, wherein a type of the plurality of rules comprises at least one of a url rule, a variable rule and a cookie rule.

7. The computer-implemented method as recited in claim 1, wherein the execution of each of the plurality of tags being done based on a matching process, wherein the matching process matches the one or more advertiser conditions provided by the one or more advertisers with the one or more event types on the corresponding one or more publishers, wherein the matching being done for the execution of a relevant tag defined based on a matched advertiser condition of the one or more advertiser conditions.

8. The computer-implemented method as recited in claim 1, further comprising storing, with the processor, the plurality of rules, the plurality of tags, the first set of information associated with the one or more event types, information associated with the execution of each of the plurality of tags, the one or more advertiser conditions and information associated with the one or more users.

9. The computer-implemented method as recited in claim 1, wherein the event type being a function of one or more pre-defined matching techniques, wherein the one or more pre-defined matching techniques comprising at least one of an exact match, no match, regular expression matching and conditional parameters matching.

10. The computer-implemented method as recited in claim 1, wherein each of the plurality of tags comprises one or more tag supports, wherein the one or more tag supports comprises at least one of a platform level tag, a third party HTML tag and a third party URL tag.

11. A computer-program product for enabling management of a plurality of tags embedded on a plurality of web pages associated with one or more publishers, comprising:
a computer readable storage medium having a computer program stored thereon for performing the steps of:
defining a plurality of rules for each of the plurality of tags embedded in each of the plurality of web pages, wherein each of the plurality of rules being defined based on a pre-determined criterion, wherein each rule of the plurality of rules being defined for execution of a corresponding tag of the plurality of tags, wherein each of the plurality of rules being defined by one or more advertisers and wherein each of the plurality of rules being created based on an event type and wherein each of the plurality of tags being contained in a tag container;
receiving a first set of information associated with one or more event types on the corresponding one or more publishers, wherein the one or more event types corresponds to a specific set of pre-defined actions taken by one or more users on the corresponding one or more publishers containing the plurality of tags and wherein the first set of information being received in real time;
executing each of the plurality of tags based on the pre-determined criterion, wherein each of the plurality of tags being executed based on the corresponding plurality of rules defined for each of the plurality of tags, wherein a specific tag of the plurality of tags being executed on execution of the rule of the plurality of rules corresponding to the specific tag and wherein the execution of each of the plurality of tags being based on the received first set of information; and
generating a file based on changes in each of the plurality of tags, wherein the file being created for each of the plurality of tags, wherein the file being generated for determining the specific tag of the plurality of tags executed on the corresponding one or more publishers and wherein the generated file being dynamically pushed to a server.

12. The computer-program product as recited in claim 11, further comprising dynamically updating each of the plurality of rules based on the pre-determined criterion, the first set of information associated with the one or more event types and a content corresponding to the generated file.

13. The computer-program product as recited in claim 11, wherein the pre-determined criterion comprises one or more advertiser conditions provided by the one or more advertisers for the execution of each of the plurality of tags, wherein each of the one or more advertisers being associated with the corresponding tag of the plurality of tags and wherein each of the one or more advertiser conditions being provided for targeting a specific group of users for serving one or more advertisements.

14. An advertisement tag management system for enabling management of a plurality of tags embedded on a plurality of web pages associated with one or more publishers, the advertisement tag management system comprising:
a rule creation engine in a processor, the rule creation engine being configured to define a plurality of rules for each of the plurality of tags embedded in each of the plurality of web pages, wherein each of the plurality of rules being defined based on a pre-determined criterion, wherein each rule of the plurality of rules being defined for execution of a corresponding tag of the plurality of tags, wherein each of the plurality of rules being defined by one or more advertisers and wherein each of the plurality of rules being created based on an event type and wherein each of the plurality of tags being contained in a tag container;
a receiving module in the processor, the receiving module being configured to receive a first set of information associated with one or more event types on the corresponding one or more publishers, wherein the one or more event types corresponds to a specific set of pre-defined actions taken by one or more users on the corresponding one or more publishers containing the plurality of tags and wherein the first set of information being received in real time;
a tag execution engine in the processor, the tag execution engine being configured to execute each of the plurality of tags based on the pre-determined criterion, wherein each of the plurality of tags being executed based on the corresponding plurality of rules defined for each of the plurality of tags, wherein a specific tag of the plurality of tags being executed on execution of the rule of the plurality of rules corresponding to the specific tag and wherein the execution of each of the plurality of tags being based on the received first set of information; and
a file generating module in the processor, the file generating module being configured to generate a file based on changes in each of the plurality of tags, wherein the file being created for each of the plurality of tags, wherein the file being generated for determining the specific tag of the plurality of tags executed on the corresponding one or more publishers and wherein the generated file being dynamically pushed to a server.

15. The advertisement tag management system as recited in claim 14, further comprising an updation engine in the processor, the updation engine being configured to dynamically update each of the plurality of rules based on the pre-determined criterion, the first set of information associated with the one or more event types and a content corresponding to the generated file.

16. The advertisement tag management system as recited in claim 14, wherein the pre-determined criterion comprises one or more advertiser conditions provided by the one or more advertisers for the execution of each of the plurality of tags, wherein each of the one or more advertisers being associated with the corresponding tag of the plurality of tags and wherein each of the one or more advertiser conditions being provided for targeting a specific group of users for serving one or more advertisements.

17. The advertisement tag management system as recited in claim 14, further comprising a computation engine in the processor, the computation engine being configured to analyze the generated file for determining the corresponding executed tag of the plurality of tags, wherein the analyzing being done for recognizing an advertiser of the one or more advertisers associated with the corresponding executed tag of the plurality of tags.

18. The advertisement tag management system as recited in claim 14, further comprising an advertisement serving module in the processor, the advertisement serving module being configured to display an advertisement of the one or more advertisements to a user of the one or more users on a corresponding advertisement slot of one or more advertisement slots associated with a corresponding publisher of the one or more publishers based on the computation, wherein the advertisement of the one or more advertisements being associated with the advertiser of the one or more advertisers associated with the corresponding tag of the plurality of tags being executed in real time.

19. The advertisement tag management system as recited in claim 14, wherein a type of the plurality of rules comprises at least one of a url rule, a variable rule and a cookie rule.

20. The advertisement tag management system as recited in claim 14, further comprising a database in the processor, the database being configured for storing the plurality of rules, the plurality of tags, the first set of information associated with the one or more event types, information associated with the execution of each of the plurality of tags, the one or more advertiser conditions and information associated with the one or more users.
